(19) United States
(12) Patent Application Publication
(10) Pub. No.: US 2007/0071948 A1
(43) Pub. Date: Mar. 29, 2007

(54) Method of making barrier partitions and articles

(75) Inventors: Chikafumi Yokoyama, Zama-shi (JP); Hiroshi Kikuchi, Yamato-shi (JP); Vincent W. King, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/237,810

(22) Filed: Sep. 28, 2005

(51) Int. Cl. B32B 3/00

(52) U.S. Cl. 428/172; 428/156

(57) ABSTRACT

The invention relates to methods of making barrier partitions, flexible molds (e.g. suitable for making barrier partitions), methods of making flexible molds and (e.g. plasma) display panel articles.

### BACKGROUND

A plasma display panel (PDP) generally contains a large number of fine discharge display cells. Each discharge display cell is encompassed and defined by a pair of glass substrates spaced apart from each other with barrier ribs (also called “barrier partitions”) between the glass substrates. The barrier ribs are generally a fine structure comprised of ceramic material. When a single set of parallel barrier ribs are employed, the barrier partitions form a striped pattern. In such embodiment, the discharge display cells are the trough recesses between the barrier ribs. Alternatively, the barrier ribs may have a lattice pattern.

Several barrier rib lattice patterns and method of making such are known. See for example US2003/0178938, WO 2005/013308, JP 8-273537, JP 8-273538, JP 9-283017 and JP 10-134705.

In comparison to the stripe pattern, the lattice barrier pattern typically exhibits improved vertical resolution and improved light emission efficiency. However, lattice barrier patterns are also recognized by those skilled in the art as being more difficult to manufacture.

### SUMMARY OF THE INVENTION

In one embodiment, a flexible mold (e.g. suitable for making barrier partitions) is described. The mold comprises a microstructured surface having intersecting recesses wherein at least the intersections of the recesses form obtuse angles or form curved peripheral boundaries. The mold is preferably transparent.

In another embodiment, a method of making barrier partitions is described. The method comprises providing a curable material between the microstructured surface of the mold just described and a (e.g. electrode patterned) substrate, curing the curable material, and removing the mold. The method may be repeated at least 5 times using the same flexible mold. The curable material may be photocured through the mold, through the glass panel, or a combination thereof.

The recesses of the mold form at least cell walls in the curable material. The curved peripheral boundary may have a radius of curvature ranging from 5% to 50% of the cell wall length. Adjacent cell walls are typically joined by a curved peripheral boundary that extends the entire height of the intersection of the cell walls. For embodiments wherein the cell walls are joined by a curved peripheral boundary and uncurved portions of adjacent intersecting cell walls may form an angle of about 90° or less. Alternatively, the cell walls form polygons having more than four sides in planar view such as hexagons or octagons. The cell walls may also intersect with a base surface wherein the intersections form obtuse angles or form curved peripheral boundaries. The substrate or the curable material may form the base surface of the cells. The cell walls may form closed cells.

In another embodiment, a method of making a flexible mold is described. The method comprises providing a (e.g. master or transfer) mold having a microstructured surface with the reverse structure of the flexible mold, providing a polymerizable resin composition in at least the recesses of the microstructured surface of the mold; contacting the surface of polymerizable resin composition, opposite the microstructured surface of the mold, with a support; curing the polymerizable resin composition, and removing the cured polymerizable resin composition together with the support from the polymeric transfer mold, thereby forming a flexible mold.

In yet another embodiment a display component is described that comprises a continuous barrier partition layer consisting of a glass or ceramic material and a plurality of recesses having walls that define cells, wherein at least the intersections of the walls form obtuse angles or form curved peripheral boundaries and the base of the cells is comprised of the same material as the cell walls.

### BRIEF DESCRIPTION OF THE DRAWINGS

FIG. 1 is a sectional view schematically showing an illustrative plasma display panel.

FIG. 2A-2C is a sectional view showing an exemplary method of making a display back plate by use of a flexible mold.

FIG. 3 is a perspective view of illustrative lattice pattern barrier partitions.

FIG. 4 is a sectional view of the cells and lattice pattern barrier partitions taken along V-V and VI-VI of FIG. 3.

FIG. 5 is a transverse cross-sectional view showing exemplary lattice pattern barrier partitions.

FIG. 6A-6C is a sectional view showing an exemplary method of making a flexible mold.

### DETAILED DESCRIPTION OF THE PREFERRED EMBODIMENTS

The invention relates to methods of making barrier partitions, flexible molds (e.g. suitable for making barrier partitions), methods of making flexible molds and (e.g. plasma) display panel articles. In the description that follows, embodiments of the invention will be explained in detail with respect to the production of lattice pattern barrier partitions suitable for a (e.g. plasma) display panel as an exemplary fine structure. However, the invention is surmised useful for other microstructured articles.

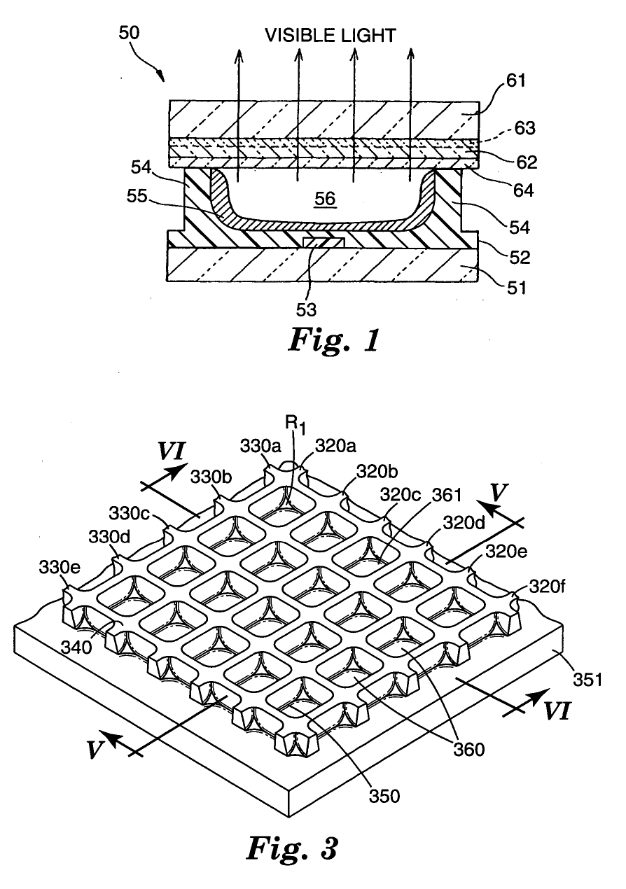

A (e.g. plasma) display panel may contain a large number of discharge display cells. For example, the number of discharge cells typically ranges from about two to about eighteen million for 42-inch displays. As schematically shown in FIG. 1, each discharge display cell 56 is encompassed and defined by a pair of substrates, 51 and 61, spaced apart from each other in combination with barrier structures 54 arranged between the substrates that separate areas in which red (R), green (G), and blue (B) phosphors are deposited. A transparent substrate 61 (e.g. glass) is provided on the front (i.e. viewing) surface and a back (i.e. non-viewing) substrate 51, is also commonly glass.

The front surface glass substrate 61 is equipped thereon with a transparent display electrode 63 consisting of a scanning electrode and a retaining electrode, a transparent dielectric layer 62 and a transparent protective layer 64. The back surface glass substrate 51 is equipped thereon with an address electrode 53 and a dielectric layer 52. Each discharge display cell 56 has on its inner wall a phosphor layer 55, contains a rare gas (Ne—Xe gas, for example) sealed therein, and can cause spontaneous light emission display due to plasma discharge between the electrodes described above.

In one embodiment, a method of making barrier partitions is described. The method generally comprises molding a curable material (e.g. ceramic paste) with a mold having a microstructured surface, curing the curable material, and removing the mold.

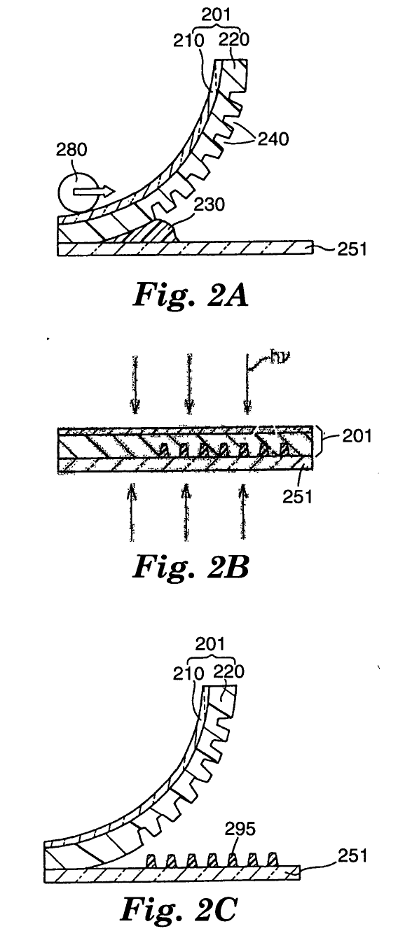

With reference to FIGS. 2A-2C flexible mold 201 typically includes a polymeric film support 210 and shape-imparting layer 220 having a plurality of intersecting grooves 240 suitable for producing lattice patterned barrier partitions. Prior to use, the flexible mold or components thereof may be conditioned in a humidity and temperature controlled chamber (e.g. 22° C./55% relative humidity) to minimize the occurrence of dimensional changes during use. Such conditioning of the flexible mold is described in further detail in WO2004/010452; WO2004/043664 and JP Application No. 2004-108999, filed Apr. 1, 2004; incorporated herein by reference.

With reference to FIG. 2A, a transparent substrate 251 such as a flat glass sheet having preapplied electrodes (not shown) is provided. The flexible mold 201 is positioned such that the electrodes will be aligned between the barrier partitions. A transparent mold is advantageous for such positioning since it is possible to locate the electrodes through the mold. The positioning may be conducted manually with eyesight or by use of a sensor such as a charge coupled device camera. Aligning the microstructures of the mold with the (e.g. electrode) patterned substrate by means of stretching the mold is described in U.S. Pat. No. 6,616,887. Once positioned, it is preferred to maintain constant temperature and the humidity.

A barrier partition precursor composition 230, such as a curable ceramic paste can be provided between the substrate and the shape-imparting layer of the flexible mold in a variety of ways. The curable material can be placed directly in the pattern of the mold followed by placing the mold and material on the substrate, the material can be placed on the substrate followed by pressing the mold against the material on the substrate, or the material can be introduced into a gap between the mold and the substrate as the mold and substrate are brought together by mechanical or other means. Further, the precursor may be (e.g. uniformly) coated to the entire surface of the flat glass sheet such as described in WO03/032353.

As depicted in FIG. 2A, a (e.g. rubber) roller 280, typically driven by a motor may be employed to engage the flexible mold 201 with the barrier precursor 230. The roller 280 is typically placed at one of the end of the mold 201 with the remainder of the mold being unconstrained. As the roller 280 advances, pressure is applied to the mold 201 due to the weight of the roller 280 spreading the precursor 230 between the flat glass sheet 251 and the mold 201 filling the (e.g. groove) recess portions 240. The air, formerly filling the recesses 240, is discharged towards the periphery and then outside the mold.

After forming the precursor into lattice patterned barrier partitions with the mold, the precursor is cured. The precursor is preferably cured by radiation exposure to (e.g. UV) light rays through the transparent substrate 251 and/or through the mold 201 as depicted on FIG. 2B. As shown in FIG. 2C, the flexible mold 201 is removed while the resulting cured barrier partitions 295 remain bonded to the substrate 251.

The barrier partitions (e.g. together with the a flat glass sheet having preapplied electrodes) are sintered or fired. Firing temperatures may vary widely from about 400° C. to 1600° C., but typical firing temperatures for PDPs manufactured onto soda lime glass substrates range from about 400° C. to about 600° C., depending on the softening temperature of the ceramic powder in the slurry. The front substrate preferably has the same or about the same coefficient of thermal expansion as that of the back substrate.

The curable rib precursor (also referred to as “slurry” or “paste”) typically comprises at least three components. The first component is a glass- or ceramic-forming particulate material (e.g. powder). The powder will ultimately be fused or sintered by firing to form microstructures. The second component is a curable organic binder capable of being shaped and subsequently hardened by curing, heating or cooling. The binder allows the slurry to be shaped into rigid or semi-rigid “green state” microstructures. The binder typically volatilizes during debinding and firing and thus may also be referred to as a “fugitive binder”. The third component is a diluent. The diluent typically promotes release from the mold after hardening of the binder material. Alternatively or in additional thereto, the diluent may promote fast and substantially complete burn out of the binder during debinding before firing the ceramic material of the microstructures. The diluent preferably remains a liquid after the binder is hardened so that the diluent phase-separates from the binder material during hardening. The rib precursor preferably has a viscosity of less than 20,000 cps and more preferably less than 5,000 cps to uniformly fill all the microstructured groove portions of the flexible mold without entrapping air.

Photocurable rib precursor compositions further comprise one or more photoinitiators at a concentrations ranging from 0.01 wt-% to 1.0 wt-% of the polymerizable resin composition. Suitable photointitiators include for example, 2-hydroxy-2-methyl-1-phenylpropane-1-one; 1-[4-(2-hydroxyethoxy)-phenyl]-2-hydroxy-2-methyl-1-propane-1-one; 2,2-dimethoxy-1,2-diphenylethane-1-one; 2-methyl-1-[4-(methylthio)phenyl]-2-morpholino-1-propanone; and mixtures thereof.

The rib precursor may optionally comprise various additives including but not limited to surfactants, catalysts, etc. as known in the art. For example, the rib precursor may comprise 0.1 to 1 parts by weight of a phosphorus-based compound alone or in combination with 0.1 to 1 parts by weight of a sulfonates based compounds. Such compounds are described in PCT Publication No. WO2005/019934; incorporated herein by reference. Further, the rib precursor may comprise an adhesion promoter such as a silane coupling agent to promote adhesion to the substrate (e.g. glass panel of PDP).

The amount of curable organic binder in the rib precursor composition is typically at least 2 wt-%, more typically at least 5 wt-%, and more typically at least 10 wt-%. The amount of diluent in the rib precursor composition is typically at least 2 wt-%, more typically at least 5 wt-%, and more typically at least 10 wt-%. The totality of the organic components is typically at least 10 wt-%, at least 15 wt-%, or at least 20 wt-%. Further, the totality of the organic compounds is typically no greater than 50 wt-%. The amount of inorganic particulate material is typically at least 40 wt-%, at least 50 wt-%, or at least 60 wt-%. The amount of inorganic particulate material is no greater than 95 wt-%. The amount of additive is generally less than 10 wt-%.

A preferred ceramic paste composition is described in U.S. application Ser. No. 11/107,608, filed Apr. 15, 2005.

It has been discovered that when lattice pattern barrier ribs are molded wherein the peripheral boundaries of the cell walls form angles of 90°, portions of the barrier ribs can be missing upon removal of the mold. Such missing portions are referred to are “tipping defects”. This defect is caused from the curable (e.g. paste) material adhering to the mold at the peripheral boundaries of the groove portions of the mold. The size of the missing portion can range in maximum dimension from 10 to 50 microns. This defect has been found more pronounced with multiple reuses of the same flexible mold.

It has been found that the occurrence of tipping defects can be reduced by providing a flexible mold wherein the intersections of the recesses of the shape-imparting layer and thus intersections of adjacent cell walls form obtuse angles or have curved peripheral boundaries. In preferred embodiments, the barrier partition layer is substantially free of tipping defects. In more preferred embodiments, the barrier partition layer is free of tipping defects after the flexible mold has been used any number of times from at least one reuse to at least 5 reuses. In preferred embodiments, the flexible mold may be reused at least 10 times, at least 20 times, or at least 30 times without tipping defects in the barrier partition layer thus formed.

In one aspect, the occurrence of defects can be reduced by employing a flexible mold wherein the intersection of the (e.g. groove) recesses of the shape-imparting layer and thus cell walls subsequently formed, comprise peripheral boundaries that form obtuse angles, i.e. greater than 90°. Preferably, the angle is at least 100°, more preferably at least 120°, and more preferably at least 140°. This can be accomplished by employing a mold that forms cells that form the shape of polygons having more than four sides in plane view. The number of sides may range for example from 5 (i.e. pentagons) to 12 for example.

In a more preferred embodiment, the occurrence of defects is reduced by providing a flexible mold wherein the intersection of the (e.g. grooves) recesses of the shape-imparting layer, and thus the cell walls subsequently formed, have curved peripheral boundaries. In this embodiment, the curvature aids in the removal of the mold without breakage of the barrier partitions. Accordingly, the cells may have other shapes wherein the intersection of the cell walls, i.e. in the absence of the curvature would form angles of 90° or less. Preferably, however, the cell walls in the absence of the curvature form angles of at least about 90°.

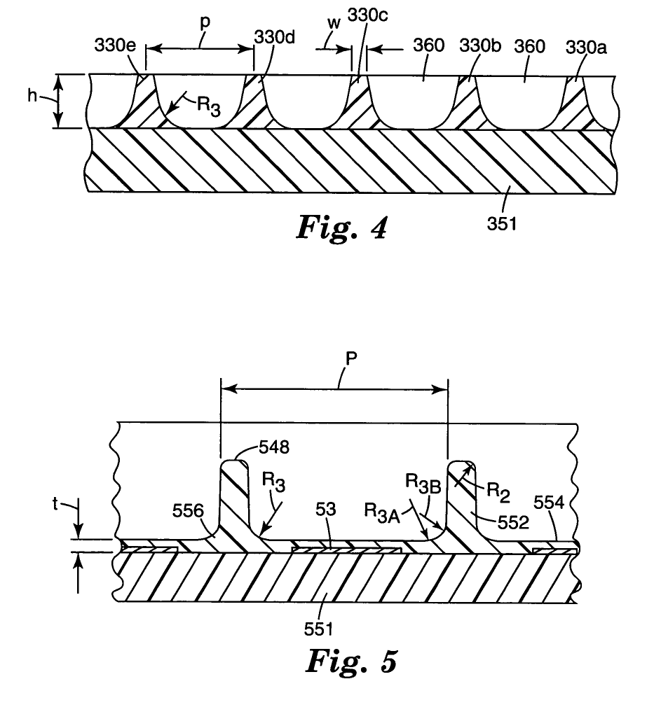

With reference to FIGS. 3-4, a preferred embodied lattice patterned barrier partition layer comprises a first set of parallel barrier ribs 320a, 320b, 320c, 320d, 320e and 320f and a second set of parallel barrier ribs 330a, 330b, 330c, 330d, and 330e. The first set of barrier ribs intersect the second set of barrier ribs forming a plurality of discharge cells 360. Each cell can be defined by a first pair of adjacent parallel barrier ribs intersecting a second pair of adjacent parallel barrier ribs e.g. cell 361 is defined by 320c and 320d intersecting 330a and 330b. The cells may have the same or different dimensions. The depicted cells are substantially quadrilateral in shape (e.g. square or rectangular) having curved surfaces at the locations where the barrier ribs intersect each other, i.e. at least at the corners of the cells. The curvature of the barrier partition intersections is evident at cross sections that intersect a row of cells near the corners of the cells such as along line V-V and VI-VI of FIG. 3. It is appreciated that the extent of curvature will vary depending on the location of the cross section.

Unlike stripe-patterned barrier ribs having curved surfaces, the curvature of lattice pattern barrier ribs is evident in a first direction (e.g. V-V) and a second direction (VI-VI) substantially orthogonal to the first direction. Further, the curvature preferably extends the entire height of the barrier rib such that the curvature of the cell walls is evident in a perspective view, as shown in FIG. 3.

If the cells are only rounded at the intersection of the cell walls, depending on the degree of curvature a peripheral boundary between for example the center of a cell and substrate 351 may intersect at an angle of 90°. However, it is preferred that the intersection of the cell walls with the bottom surface of the cell, such as locations (e.g. 350) where the cell walls contact substrate 351 also have peripheral boundaries and/or form obtuse angles. In such embodiment, the obtuse angularity and/or curvature is typically evident in any cross-sections through the cell, regardless of the location of the cross section.

In yet other aspects, the cells may be circular or elliptical in shape. This can be accomplished by use of a flexible mold wherein the shape-imparting surface comprises a pattern of circular or elliptical shaped protrusions.

Although the flexible mold may optionally comprise a shape-imparting layer that forms open cells, in at least some embodiments, the barrier rib structures form closed (e.g. discharge) cells, the cell walls being continuous about the entire peripheral boundaries of the cell from the base to the top surface of the cells. The cells are typically entirely closed at all peripheral boundaries once the barrier structure layer is disposed between the two (i.e. planar) substrates, (e.g. 51 and 61 with reference to the plasma display panel of FIG. 1). However, it is appreciated that the cells of the barrier structure layer alone, prior to incorporation into the plasma display panel, are typically open on at least one major (e.g. top) surface 340, as depicted in FIG. 3.

With reference to FIGS. 4 and 5, the dimensions of the lattice pattern barrier partitions can vary. The height (“h”) of the barrier partitions and thus the height of the discharge cell wall is generally at least about 50 μm and typically no greater than about 500 μm. Preferably, the height is at least about 100 μm and no greater than about 300 μm. The pitch (“p”) of the barrier partitions (i.e. distance from the center of a first barrier partition to the center of a second adjacent parallel barrier partition) is generally at least about 100 μm and typically no greater than about 1,000 μm. Preferably, the pitch is at least about 150 μm and no greater than about 800 μm. The pitch corresponds to the cell wall length. The width (“w”) of the barrier partitions is generally at least about 10 μm and typically no greater than about 100 μm. Preferably, the width is at least about 30 μm and no greater than about 80 μm. The width of the barrier partitions may be different at the upper surface than at the lower surface. Tapered barrier partitions tend to facilitate removal of the mold in methods of manufacture that involve molding a ceramic paste material.

Typically it is preferred that the barrier partitions are slightly larger at the bottom surface gradually tapering toward the upper surface. In at least some embodiment, it is preferred that the width of the barrier partitions is smaller in width at the upper surface in comparison to the bottom surface such that the included angle to a plane orthogonal to the substrate is no more than 20°.

Although the cells may have the same dimension within an array and thus have the same pitch and width, cells having different pitch and width may be present within an array.

In some instances, it is useful to define the curved surface by a radius of curvature R. The radius of curvature R and the curvature κ, are inversely proportional to each other and can be represented by the equation:
R=1/κ
As the radius of curvature R increases, the curvature κ, decreases. The radius of curvature R for a curved surface can be described relative to other dimensions of the microstructure, for example, the barrier portion height “h”, the barrier portion width “w”, or the land portion thickness “t” (as depicted in FIG. 5), or the cell wall length “p” i.e. distance between opposing (e.g. parallel) barrier partitions.

In one aspect, the curved surface of the microstructure has a single radius of curvature. This indicates that the curvature κ does not change at any point along the curved surface. The shape of the curved surface can be identical to the shape of an arc of a circle, wherein the radius of the circle is equal to the radius of curvature R of the curved surface. The radius of curvature R can be selected based on other dimensions of the microstructure. For example, the radius of curvature R can be a fraction of the cell wall length.

The curved surfaces R₁ of the cell typically have a radius of curvature of at least 5% of the cell wall length, preferably at least 10%, and more preferably at least 12%. Further, the radius of curvature is typically no greater than 80% of the cell wall length. In at least some embodiments, the preferred radius of curvature is less than about 50% of the barrier partition height and more preferably about 25% or less.

In some embodiments, such as depicted in FIG. 5, the rib top edges may also be curved. This curvature R₂ also tends to facilitate removal of the mold. The radius of curvature of the rib top is at least 3% of the barrier rib width, preferably at least 5%, and more preferably at least 10%. Further, to ensure that a portion of the barrier rib top 548 remains flat, the radius of curvature is typically no more than 80% of the barrier rib width. In at least some embodiments, the preferred radius of curvature is less than about 75% of the barrier rib width and more preferably about 70% or less.

In other embodiments, such as depicted in FIG. 5, the intersection of the barrier rib with the base surface may be curved. This curvature R₃ also facilitates removal of the mold. This radius of curvature is in the range of 5% to 80% of the barrier rib height, in the range of 10% to 50% of the barrier rib height, or in the range of 12% to 25% of the barrier rib height.

In another embodiment of the invention, the curved surface may be defined by more than one radius of curvature. For example the cell may have a different radius of curvature from the midpoint of the barrier partition intersection to one barrier partition (e.g. first set) and a different radius of curvature from that midpoint to a (e.g. orthogonal) barrier partition. Also the radius of curvature may typically be different on the top of the cell in comparison to the bottom of the cell, particularly if the barrier partitions are tapered.

In some embodiments, a curved surface that includes more than one radius of curvature may be substantially continuous (i.e., contains no surface discontinuities). In one example of this embodiment, as illustrated in FIG. 5, two radii of curvature, R_{3A} and R_{3B} define the curved surface 556 where the land surface 554 meets the curved surface 556 and the curved surface 556 meets the barrier surface 552, respectively. More than two radii of curvature can be used. For example, the curved surface includes radii of curvature that are between the values of R_{3A} and R_{3B} for individual points on the curved surface 556. The change in the radii of curvature for points along the curved surface 556 follows the function of the curved surface. It is understood that variations in the radius of curvature can be used in combination with any of the shapes of the curved surfaces of the microstructures as described for any of the embodiments depicted in FIGS. 4 and 5. In some embodiments, such as depicted in FIG. 3, the base of the cell may be a different material than the barrier partitions. In other embodiments, such as depicted in FIGS. 1 and 5, the base of the cells and the cell walls are comprised of the same (e.g. ceramic) material. A continuous layer of curable ceramic material is thus disposed between the substrate of the display and the base of the cells.

In other embodiments, back panels and (e.g. plasma) displays are described having certain barrier structures. The barrier structures consist of a glass or ceramic material. The peripheral boundaries of the cells are curved, form obtuse angles, or combinations thereof. The barrier partitions and the bottom surface of the cell are comprised of the same (e.g. cured ceramic paste) material. This can be accomplished for example with the method described is WO03/032353 wherein a substantially uniform coating of a curable material (e.g. cured ceramic paste) is formed on a substrate. The coating is contacted with a mold to form in the curable material the barrier partitions connected by intervening land regions. Accordingly, a continuous layer of the ceramic material is provided adjacent the (e.g. glass panel) substrate beneath the base of the cells. Further, the interior surface of the cell, except for the top glass plate, is comprised of the mold curable material (e.g. ceramic paste).

Although, molding of the barrier partitions is preferred, the novel barrier partitions described herein can alternatively formed by other methods such an sand blasting, embossing and chemical etching, as known in the art.

In other embodiments, the invention relates to a master molds, transfer molds, and flexible molds as well as various replications of such molds. In general, the flexible mold has the inverse pattern of the barrier partitions to be made. In some aspects the flexible mold is prepared from a transfer mold (having the same pattern as the barrier partitions), which in turn is prepared from a master mold (having the inverse pattern). Suitable transfer molds are described in JP Application 2004-001108 filed Jan. 6, 2004. Alternatively, the flexible mold can be prepared directly from a master mold having the same pattern as the barrier partitions such as described in WO 2005/013308.

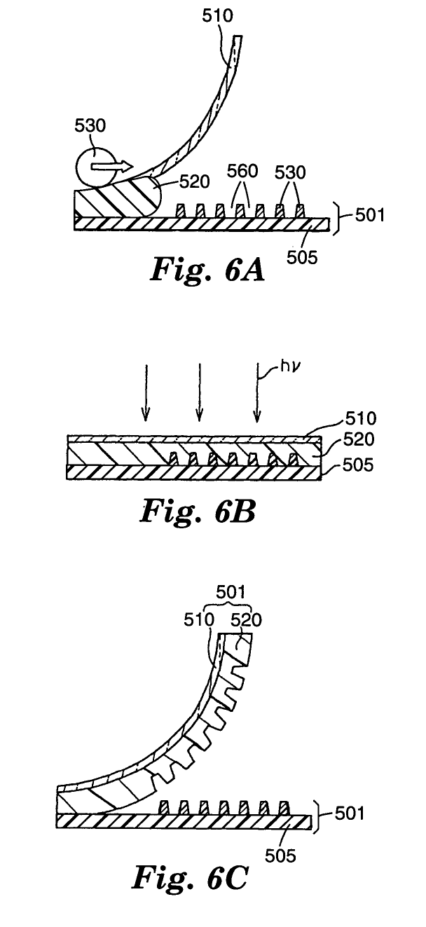

The flexible mold can be produced in accordance with various known methods. For example, the flexible mold can be produced in the manner (e.g. sequentially) depicted in FIGS. 6A-6C.

The master or transfer mold 501 having dimensions (i.e. shape and the size) corresponding to the eventual barrier partitions may include a support layer or base substrate 505 and projections 530. A curable molding material 520 is applied to an end face of the master mold 501 by use of, for example, a knife coater or a bar coater. A laminate (e.g. rubber) roll 530 can be used to contact a flexible film 510 to the master mold 501 containing the curable molding material. The laminate roll 530 is advanced in the direction indicated by an arrow. As a result, the molding material 520 is spread uniformly to a predetermined thickness and fills the gaps 560 of the projections 530. Advancing the molding material 520 with film 510 minimizes air entrapment. After the molding material is disposed between the film and the mold as depicted in 6B, the mold material is cured. In a preferred embodiment, the molding material is photocurable and thus irradiated with ultraviolet rays (hν) through the (i.e. transparent) support film 510 as indicated by the arrows in FIG. 6B.

The flexible film provides dimensional stability and a supportive structure for the molding material 520 even while the molding material 520 undergoes shrinkage during the curing process. The flexible film may be comprised of a variety of polymeric materials such as polyethylene terephthalate (PET), polyethylene naphthalate (PEN), stretched polypropylene, and polycarbonate and triacetate, etc. For embodiments wherein the curable molding material is photocured, it is preferred that the flexible film has sufficient transparency to transmit the ultraviolet rays irradiated through the flexible film layer. The thickness of the flexible film is generally at least about 50 μm and more typically at least about 100 μm. Further, the flexible film typically has a thickness of less than 500 μm and more typically less than about 400 μm. The flexible film may be surface treated to improve adhesion of the molding material. The flexible film may be preconditioned in a humidity and temperature controlled environment as previously described.

A variety of curable compositions are suitable for use as the molding material. For example, a UV-curable composition containing an acryl monomer and/or oligomer as its main component can advantageously be used. Suitable acryl monomers include urethane acrylate, polyether acrylate, polyester acrylate, acrylamide, acrylonitrile, acrylic acid, acrylic acid ester, etc. Suitable acryl oligomers include urethane acrylate oligomer, polyether acrylate oligomer, polyester acrylate oligomer, epoxy acrylate oligomer, etc. UV-curable compositions typically comprise a photoinitiator and other additives (e.g. antistatic agent) as desired. Preferred compositions are described in U.S. application Ser. No. 11/107,554, filed Apr. 15, 2005.

As shown in FIG. 6C the flexible mold 501, having shape-imparting layer 520, is separated from the master mold 501 while keeping its integrity.

The master mold and replications thereof are surmised suitable for the manufacture of other fine structure patterns such as (e.g. disposable) microfluidic articles that are useful in detecting and enumerating microorganisms. Microfluidic articles may be formed from a plurality of microcompartments in a culture device as well as a biological or chemical assay device. For example, the fine structured pattern can be advantageously used in the form of articles disclosed in U.S. Pat. No. 6,696,286.

### EXAMPLES

### Example 1

A lattice patterned master tool was prepared as described in WO2005/013308. The vertical partition had a top width of 80 microns, a bottom width of 175 microns, and a height of 215 microns. The lateral partition had a top width of 110 microns, a bottom width of 270 microns, and a height of 215 microns. The lateral partitions intersected the vertical partitions forming substantially rectangular shaped cells having a radius of curvature at the intersection of 90 microns.

A flexible mold was prepared from the master tool using a UV curable resin prepared from 45 wt-% of aliphatic diacrylate oligomer, manufactured by Diacel-UCB under the trade designation “Ebecryl (EB), 45 wt-% of 2-ethyl-hexyl diglycol acrylate, 9 wt-% of 2-butyl 2 ethyl 1,3-propanediol diacrylate, and 1 wt-% of 2-hydroxyl-2-methyl-1-phenyl-propane-1-on photoinitiator manufactured by Ciba-Gigy under the trade designation “Darocure 1173”).

The acrylate was filled between the master tool and PET film, cured by exposure of 300-400 nm wavelength light for 30 sec and released together with the PET film from the master tool to obtain a flexible plastic mold as described with reference to FIGS. 6A-6C.

A photocurable ceramic paste was made as follows. 21.0 g of dimethacrylate of bisphenol A diglycidyl ether (Kyoeisha Chemical Co., Ltd.), 9.0 g of triethylene glycol dimethacrylate (Wako Pure Chemical Industries, Ltd.), 30.0 g of 1,3-butandiol (Wako Pure Chemical Industries, Ltd.), 0.2 g of bis(2,4,6-trimethylbensoil)-phenylphosphyneoxide photointiator (Ciba-Gigy under the trade designation “Irgacure 819”), 1.5 g of POCA (phosphateed polyoxyalkyl polyol) and 1.5 g of NeoPelex#25 (sodium dodecylbenzenesulfonate, made by Kao Co.) as surfactants, and 270.0 g of a mixture of glass frit and ceramic particles (RFW-030, made by Asahi Glass Co) were mixed to obtain the photocurable glass paste. The paste viscosity was 7300 cps (22° C., 20 rpm, spindle No. 5, B type viscous meter).

The paste was coated on a glass substrate in 130 micron thickness by blade coater, and then the flexible mold was laminated on the paste by rubber roller. The lamination direction is parallel to vertical grooves and is vertical to lateral grooves.

After the lamination, 400-500 nm wavelength light was exposed for 30 seconds to cure the paste and then the flexible mold was released from the substrate to obtain lattice-pattern partition. The de-molding was done in parallel to vertical partition with 90 deg peel angle.

In the same manner, the same flexible mold was reused 4 times to mold lattice patterned barrier partitions. In each of the lattice patterned barrier partitions, 240 cell wall intersections, chosen at random, were inspected with a microscope for missing barrier partition portions (“tipping defects”). No defects were found in any of the lattice patterned barrier partitions having curved cell wall intersections.

### Comparative Example

Example 1 was repeated using a lattice patterned master tool having unrounded corners that were nominally 90°. The vertical partition had a top width of 60 microns, a bottom width of 110 microns, and a height of 155 microns. The lateral partition had a top width of 60 microns, a bottom width of 150 microns, and a height of 155 microns.

In the same manner, the same flexible mold was reused 4 times to mold lattice patterned barrier partitions. In each of the lattice patterned barrier partitions, 240 cell wall intersections, chosen at random, were inspected with a microscope. The first sample had 4 tipping defects. The second sample had 34 tipping defects. The third samples had 140 tipping defects. The fourth sample had 184 tipping defects. The fifth sample had 228 tipping defects.

What is claimed is:

1. A method of making barrier partitions comprising:
providing a flexible mold comprising a microstructured surface having intersecting recesses wherein at least the intersections of the recesses form obtuse angles or curved peripheral boundaries;
providing a curable material between the microstructured surface and a substrate;
curing the curable material; and
removing the mold.

2. The method of claim 1 wherein the recesses form at least cell walls in the curable material.

3. The method of claim 2 wherein the curved peripheral boundary has a radius of curvature ranging from 5% to 50% of the cell wall length.

4. The method of claim 2 wherein adjacent cell walls are joined by a curved peripheral boundary that extends the entire height of the intersection of the cell walls.

5. The method of claim 2 wherein adjacent cell walls are joined by a curved peripheral boundary and the angle formed by intersecting uncurved adjacent cells walls is about 90° or less.

6. The method of claim 2 wherein the cell walls form polygons having more than four sides in planar view.

7. The method of claim 6 wherein the cell walls form hexagons or octagons in planar view.

8. The method of claim 2 wherein the cell walls intersect with a base surface of the cells and the intersections form obtuse angles or curved peripheral boundaries.

9. The method of claim 8, wherein the curved peripheral boundaries formed with the base surface of the cells have a radius of curvature ranging from 5% to 80% of the cell wall height.

10. The method of claim 2, wherein the cell walls further comprise a top surface, wherein a center portion of the top surface is flat and at least one top surface outer periphery edge is curved.

11. The method of claim 10, wherein the top surface outer edge periphery has a radius of curvature ranging from 3% to 75% of the cell wall width.

12. The method of claim 2, wherein the intersecting cell walls define a cell and all peripheral boundaries of the cell are curved.

13. The method of claim 2 wherein the cell walls intersect with a base surface and the base surface is a glass substrate.

14. The method of claim 2 wherein the cell walls intersect with a base surface and the base surface is the curable material of the cell walls.

15. The method of claim 2 wherein the cell walls form closed cells.

16. The method of claim 1 wherein the curing comprises photocuring through the mold, through the glass panel, or a combination thereof.

17. The method of claim 1 further comprising repeating the method at least 5 times with the same flexible mold.

18. A flexible mold comprising a microstructured surface having intersecting recesses wherein at least the intersections of the recesses form obtuse angles or form curved peripheral boundaries.

19. A method of making a flexible mold comprising
providing a mold having a microstructured surface having a plurality of recesses having walls that define cells wherein the intersection of the walls form obtuse angles or curved peripheral boundaries;
providing a polymerizable resin composition in at least the recesses of the microstructured surface of the mold;
contacting the surface of polymerizable resin composition, opposite the microstructured surface of the mold, with a support;
curing the polymerizable resin composition; and
removing the cured polymerizable resin composition together with the support, thereby forming a flexible mold.

20. A display comprising a continuous barrier partition layer consisting of a glass or ceramic material and a plurality of recesses having walls that define cells, wherein at least the intersections of the walls form obtuse angles or form curved peripheral boundaries and the base of the cells is comprised of the same material as the cell walls.
